(19) United States
(12) Patent Application Publication
(10) Pub. No.: US 2014/0096238 A1
(43) Pub. Date: Apr. 3, 2014

(54) ELECTRONIC DEVICE, OPERATOR ESTIMATION METHOD AND PROGRAM

(71) Applicant: Nikon Corporation, Tokyo (JP)

(72) Inventors: Takeshi YAGI, Tokyo (JP); Mikiya Tanaka, Chigasaki (JP)

(73) Assignee: Nikon Corporation, Tokyo (JP)

(21) Appl. No.: 14/030,370

(22) Filed: Sep. 18, 2013

Related U.S. Application Data
(63) Continuation of application No. PCT/JP2012/057335, filed on Mar. 22, 2012.

(30) Foreign Application Priority Data
Mar. 24, 2011 (JP) 2011-066103
Mar. 19, 2012 (JP) 2012-062141

(51) Int. Cl. G06F 21/32

(52) U.S. Cl. CPC G06F 21/32
USPC 726/19

(57) ABSTRACT

An electronic device includes: a touch detection section that is disposed on a side surface of a casing of a main body so as to detect a touch condition when an operator touches the main body; a touch change extraction section that extracts one of a temporal change and a spatial change in the touch based on the detected touch condition; and an estimation section that determines the identity of the operator based on the one of the extracted temporal change and spatial change in the touch.

This application claims the benefit of priority from the Japanese Patent Application No. 2011-066103 filed on Mar. 24, 2011, and Japanese Patent Application No. 2012-062141 filed on Mar. 19, 2012, and this application is a continuation application of the international application PCT/JP2012/057335 filed on Mar. 22, 2012. The entire contents of the application are incorporated herein by reference.

### BACKGROUND

1. Field of the Invention

The present invention relates to an electronic device, an operator estimation method and a program.

2. Related Art

Generally, electronic devices such as mobile phones, which are equipped with IC chips in which purchased electronic money has been input, have been used for shopping. In order to prevent unauthorized use of the electronic devices, authentication of an operator is performed.

As a method of authenticating an operator who operates a portable terminal, for example, Japanese Unexamined Patent Application, First Publication No. 2008-70920 has been known. Japanese Unexamined Patent Application, First Publication No. 2008-70920 discloses a mobile terminal device that receives input information to be specified by a handwriting operation of an operator. The mobile terminal device includes: touch information acquisition means for acquiring touch information indicating presence or absence of touch with a touch target object; movement information acquisition means for acquiring movement information for a device main body from a position of the touch with the touch target object; recognition means for recognizing the input formation based on the touch information and the movement information; and registration means for registering handwriting information by which it is possible to identify the handwriting of the operator. By cross-checking the registered handwriting information and the input information which is recognized by the recognition means, authentication of the operator is performed.

### SUMMARY

When an operator intends to use the electronic device having the contactless IC chip to which paid electronic money is input, it is necessary to prevent a third party from pretending to be the operator and using the electronic device when the device is lost or stolen. Accordingly, the operator makes the electronic money unusable by setting the electronic device in a state where the IC chip is unusable (hereinafter referred to as an IC chip lock state) in advance, and releases the lock of the IC card only when using the electronic money. The lock of the IC chip is normally released by inputting a password.

However, it takes time for the operator to input the password by pressing buttons and the like provided in the electronic device by the operator's finger. Hence, there is a problem in that it is inconvenient for the operator to input the password by pressing the buttons and the like with the operator's finger whenever the operator uses the electronic money.

An object of aspects of the present invention is to provide an electronic device, an operator estimation method, and a program capable of determining the identity of an operator who operates the main body through a simple and convenient method.

According to an aspect of the present invention, there is provided an electronic device including: a touch detection section that is disposed on a side surface of a casing of a main body so as to detect a touch condition when an operator touches the main body; a touch change extraction section that extracts one of a temporal change and a spatial change in the touch based on the detected touch condition; and an estimation section that determines the identity of the operator based on the one of the extracted temporal change and spatial change in the touch.

According to an aspect of the present invention, there is provided an electronic device including: a pressure detection section that is disposed on a side surface of a casing of a main body so as to detect pressure when an operator touches the main body; a pressure change extraction section that extracts one of a temporal change and a spatial change in the pressure which is detected by the pressure detection section; and an estimation section that determines the identity of the operator based on the one of the extracted temporal change and spatial change in the pressure.

According to an aspect of the present invention, there is provided an electronic device including: a touch detection section that is disposed on a side surface of a casing of a main body so as to detect a touch condition when an operator touches the main body; a storage unit that stores operator identification information, and touch habit information regarding touch habits of the operator as performed on the main body, in association with each other; a touch habit cross-checking section that reads the touch habit information from the storage unit and cross-checks the read touch habit information with the detected touch condition; and an estimation section that determines the identity of the operator by reading, from the storage unit, the operator identification information associated with the touch habit information cross-checked by the touch habit cross-checking section.

According to an aspect of the present invention, there is provided an electronic device including: a touch detection section that is disposed on a side surface of a casing of a main body so as to detect a touch condition when an operator touches the main body; a motion detection section that detects a motion of the casing of the main body; and an estimation section that determines the identity of the operator based on the detected touch condition and the detected motion.

Further, according to an aspect of the present invention, there is provided an operator estimation method that is executed by an electronic device having a touch detection section which is disposed on a side surface of a casing of a main body so as to detect a touch condition when an operator touches the main body, the method including: a touch change extraction step of extracting one of a temporal change and a spatial change in the touch when the operator touches the main body; and an estimation step of determining the identity of the operator based on the one of the extracted temporal change and spatial change in the touch.

Further, according to an aspect of the present invention, there is provided a program for causing a computer of an electronic device having a touch detection section, which is disposed on a side surface of a casing of a main body so as to detect a touch condition when an operator touches the main body, to execute: a touch change extraction step of extracting one of a temporal change and a spatial change in the touch when the operator touches the main body; and an estimation step of determining the identity of the operator based on the one of the extracted temporal change and spatial change in the touch.

According to the above aspects of the present invention, it is possible to estimate an operator who operates the main body by a simple and convenient method.

### BRIEF DESCRIPTION OF THE DRAWINGS

FIG. 1 is a perspective view showing a configuration of an electronic device according to a first embodiment.

FIG. 2 is a cross-sectional view showing a configuration of a part of the electronic device according to the first embodiment.

FIG. 3 is a block configuration diagram of a control device of the electronic device according to the first embodiment.

FIG. 4 is a block configuration diagram of a control unit of the electronic device according to the first embodiment.

FIG. 5 is a flowchart showing processing flow of an estimation of an operator in the first embodiment.

FIG. 6 is a block configuration diagram of a control unit of an electronic device according to a second embodiment.

FIG. 7 is a flowchart showing processing flow of the estimation of the operator in the second embodiment.

FIG. 8 is a block configuration diagram of a control unit of an electronic device according to a third embodiment.

FIG. 9 is a flowchart showing processing flow of the estimation of the operator in the third embodiment.

FIG. 10 is a block configuration diagram of a control unit of an electronic device according to a fourth embodiment.

FIG. 11 is a flowchart showing processing flow of the estimation of the operator in the fourth embodiment.

### DETAILED DESCRIPTION OF EMBODIMENTS

Hereinafter, embodiments of the present invention will be described in detail with reference to the accompanying drawings.

### First Embodiment

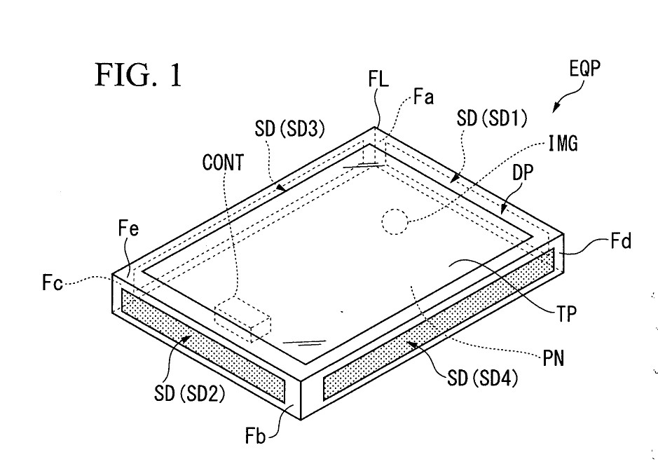

FIG. 1 is a perspective view showing a configuration of an electronic device EQP according to a first embodiment. As shown in FIG. 1, the electronic device EQP has a casing FL, a display section DP, operation sections SD, a control device CONT, and an imaging section IMG.

The casing FL is formed in, for example, a rectangular plate shape so as to hold the display section DP and the operation sections SD.

The display section DP is disposed on the planar surface of the casing FL. The surface of the casing FL, on which the display section DP is disposed, is hereinafter represented by a display surface Fe. The display section DP includes a display panel PN which has, for example, a liquid crystal device, an organic EL device, or the like. In the display region in which the display panel PN is provided, for example, a touch panel TP is provided.

The operation sections SD are provided on four side surfaces Fa to Fd which correspond to four sides surrounding the display surface Fe of the casing FL. The operation sections SD include: a touch detection section (pressure detection section) SD1 that is provided on the side surface Fa; a touch detection section (pressure detection section) SD2 that is provided on the side surface Fb; a touch detection section (pressure detection section) SD3 that is provided on the side surface Fc; and a touch detection section (pressure detection section) SD4 that is provided on the side surface Fd. The operation sections SD detects the touch position and presence or absence of the touch (of, for example, an operator) from the outside of the touch detection sections SD1 to SD4. Thereby, the touch detection sections SD1 to SD4 detect the touch condition where an operator touches the main body (the device, that is, the main body of the electronic device operated by the operator). In addition, each of the touch detection sections (pressure detection sections) SD1 to SD4 can be divided into an arbitrary number of points equal to or greater than one point. Each of the touch detection sections (pressure detection section) SD1 to SD4 can be divided into a plurality of pieces, and can be disposed at a plurality of locations. Each of the touch detection sections (pressure detection sections) SD1 to SD4 may be constituted by the detection sections disposed at a plurality of locations. For example, assuming that the touch detection section SD1 is divided into five points, the touch detection section SD1 is able to detect the presence or absence of the touch through the five points.

Further, the touch detection sections SD1 to SD4 also function as pressure sensors, and detect the pressures, which occur when the touch is performed, through a predetermined number of steps (for example, 256 steps). Thereby, the touch detection sections SD1 to SD4 detect the pressure which occurs when the operator touches the main body. For example, assuming that the touch detection section SD1 is divided into five points, the touch detection section SD1 is able to detect the pressure through the five points.

The imaging section IMG is provided inside the casing FL. Further, a lens of the imaging section IMG is provided on a surface opposite to the display surface Fe. The imaging section IMG captures an image of a subject outside the electronic device EQP, thereby generating image data which is obtained by image capturing.

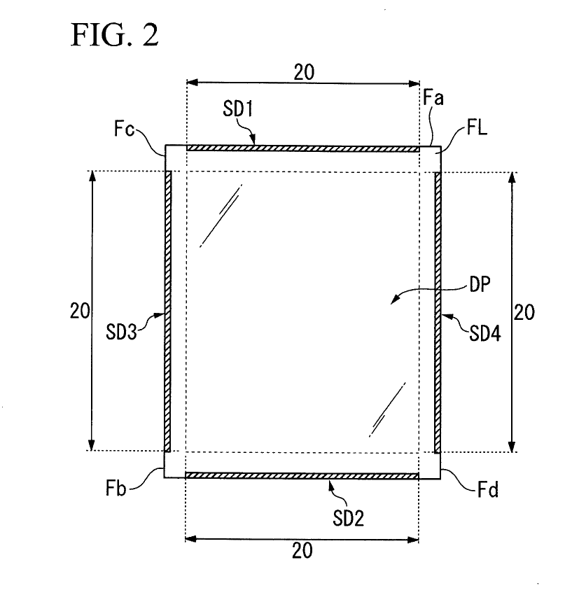

FIG. 2 is a cross-sectional view showing a configuration of a part of the electronic device. FIG. 2 is a drawing of the electronic device EQP as viewed from the display surface Fe side, and shows the touch detection sections SD1 to SD4 in cross-section.

As shown in FIG. 2, each of the touch detection sections SD1 to SD4 is disposed at a position on each side of the display section DP which is formed in a rectangular shape, and is formed to have dimensions corresponding to the dimensions of the display section DP.

Specifically, the detection regions 20 of the touch detection sections SD1 and SD2 are disposed at positions corresponding to short sides of the display section DP. Further, the dimensions of the detection regions 20 of the touch detection sections SD1 and SD2 in the length direction are set to be the same as the dimensions of the short sides of the display section DP. On the other hand, the detection regions 20 of the touch detection sections SD3 and SD4 are disposed at positions corresponding to long sides of the display section DP. Further, the dimensions of the detection regions 20 of the touch detection sections SD3 and SD4 in the length direction are set to be the same as the dimensions of the long sides of the display section DP.

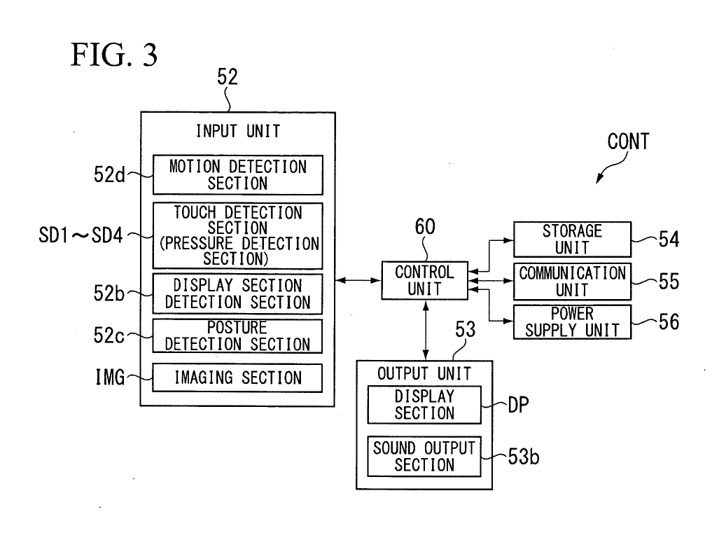

FIG. 3 is a block configuration diagram of the control device CONT. As shown in FIG. 3, the control device CONT includes a control unit 60, an input unit 52, an output unit 53, a storage unit 54, a communication unit 55, and a power supply unit 56.

The control unit 60 performs integral arithmetic processing of the electronic device EQP. The input unit 52 is a unit that performs an input to the electronic device EQP. The input unit 52 includes the touch detection sections SD1 to SD4, a display section detection section 52b, a posture detection section 52c, a motion detection section 52d, and an imaging section IMG. Besides, as the input unit 52, a sound input section, such as a microphone, not shown in the drawing may be provided.

The display section detection section 52b detects the touch position and presence or absence of the touch on the touch panel TP. The posture detection section 52c is a sensor that detects the posture of the electronic device EQP. As the posture detection section 52c, for example, a triaxial acceleration sensor, a gyro sensor, a geomagnetic sensor, or the like is provided. The motion detection section 52d detects the motion of the casing of the main body, that is, detects the motion of the casing of the main body when an operator activates the main body. As the motion detection section 52d, for example, an acceleration sensor or the like is provided.

The touch detection sections SD1 to SD4 detect a touch condition when the operator touches the main body. As the touch detection sections SD1 to SD4, for example, capacitance type touch sensors are provided.

The output unit 53 outputs an image, a sound, or the like. The output unit 53 includes a display section DP that displays the image and a sound output section 53b that controls the output of the sound.

The storage unit 54 stores results of computation which is performed by the control unit 60, input information which is input to the input unit 52, output information (for example, image data, and sound data) which is output by the output unit 53, information which is communicated through the communication unit 55, and the like. Further, the storage unit 54 stores programs of applications which are executed by the control unit 60.

Further, the storage unit 54 includes a contactless IC chip to which paid electronic money is input. The storage unit 54 stores information which indicates a registered person capable of releasing a state (IC chip lock) where the IC chip is unusable.

Further, the storage unit 54 stores information pieces o_(l, l), . . . , and o_(m, n) (m and n are positive integers) which indicate operators, information pieces Rs_l, . . . , and Rs_m which indicate touch conditions, and information pieces Rm_l, . . . , and Rm_n which indicate motion conditions, in association with each other. That is, in the storage unit 54, the information o_(i, j), which indicates a single operator, is stored in association with each combination of the information Rs_i which indicates the touch condition and the information Rm_j which indicates the motion condition (i and j are positive integers). Here, the information o_(i, j), which indicates a single operator, may be the same as information o_(i′, j′) which indicates another operator (i′ and j′ are positive integers).

The communication unit 55 is configured to be able to communicate information with the outside by at least one of wire and wireless systems. In the power supply unit 56, a power supply for supplying electric power to the electronic device EQP is disposed. Examples of the power supply unit 56 include an electric cell, a battery, and the like.

Next, operations of the electronic device EQP, which is configured as described above, will be described.

The display section detection section 52b detects the touch position on the touch panel TP, and outputs information, which indicates the touch position, to the control unit 60. The control unit 60 executes processing corresponding to identification display on the touch position. For example, when the operator touches a portion overlapping with the display region 31 not shown in the drawing on the touch panel TP, the control unit 60 performs processing corresponding to the display region 31.

The posture detection section 52c detects the posture of the casing FL of the main body, and outputs information a, which indicates the detected posture, to the control unit 60. The control unit 60 controls the direction of the display on the display section DP so as to set the direction to the direction of gravity, based on the information indicating the posture which is input from the posture detection section 52c.

The motion detection section 52d detects the motion of the casing of the main body, and outputs information mt, which indicates the detected motion, to the control unit 60.

The touch detection sections SD1 to SD4 detect the touch condition when the operator touches the main body, and output information s, which indicates the detected touch condition, to the control unit 60.

The imaging section IMG captures an image of a subject outside the electronic device EQP, based on the control signal which is used to control the image capturing by the control unit 60, generates image data which is obtained by the image capturing, and outputs the image data to the control unit 60.

The control unit 60 stores the image data, which is acquired from the imaging section IMG in the storage unit 54.

The control unit 60 reads the image data which is stored in the storage unit 54, outputs the read image data to the display section DP, and displays the image data as an image on the display section DP. Further, the control unit 60 reads a program of an application which is stored in the storage unit 54, and executes the program, thereby displaying a predetermined image, which is determined by the program, on the display section DP.

The control unit 60 outputs the image data, which is input through the communication unit 55, to the display section DP, and displays the image data as an image on the display section DP.

Further, the control unit 60 reads sound data which is stored in the storage unit 54, outputs the read sound data to the sound output section 53b, and causes the sound output section 53b to output sound.

Furthermore, the control unit 60 performs control to communicate data including the image data and the sound data with the external devices through the communication unit 55.

In the control device CONT, the output and communication operations are performed based on the operation of the operator. It should be noted that the processing of the control unit 60 is processing of the control unit (60, 60b, 60c, or 60d) common to the first to fourth embodiments, and a description thereof will be omitted in and after the second embodiment.

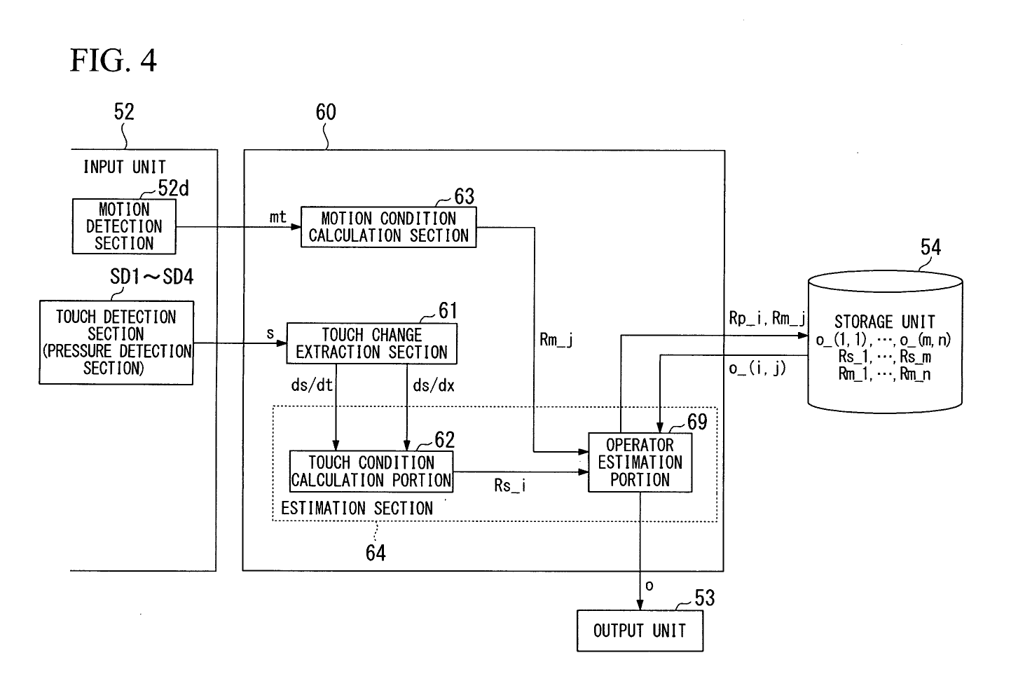

FIG. 4 is a block configuration diagram of the control unit 60. The control unit 60 includes a touch change extraction section 61, a motion condition calculation section 63, and an estimation section 64. The estimation section 64 includes a touch condition calculation portion 62, and an operator estimation portion 69.

The touch change extraction section 61 extracts one of the temporal change and the spatial change in the touch, based on the information s which indicates the touch condition detected by the touch detection sections SD1 to SD4, and outputs information ds/dt, which indicates the extracted temporal change in the touch, and information ds/dx, which indicates the spatial change in the touch, to the touch condition calculation portion 62.

Specifically, for example, the touch change extraction section 61 calculates the temporal change according to presence or absence of the touch at the positions of the touch detection sections SD1 to SD4, and outputs the information ds/dt, which indicates the temporal change according to presence or absence of the touch, to the touch condition calculation portion 62.

Likewise, for example, in accordance with the presence or absence of the touch at each of the touch detection sections SD1 to SD4, the touch change extraction section 61 calculates the change in the length direction at each touch detection section, and outputs information, which indicates the change in the length direction according to the presence or absence of the touch, as the information ds/dx, which indicates the spatial change in the touch, to the touch condition calculation portion 62.

It should be noted that the touch change extraction section 61 may extract spatial distribution of the touch based on the information s, which indicates the touch condition, and may output information, which indicates the spatial distribution of the touch, to the touch condition calculation portion 62. In this case, the touch condition calculation portion 62 extracts the touch condition based on the information which indicates the extracted spatial distribution of the touch.

The motion condition calculation section 63 calculates the motion condition information Rm_j a is a positive integer), which indicates the characteristic of the motion, based on the information mt which indicates the motion detected by the motion detection section 52d, and outputs the calculated motion condition information Rm_j to the operator estimation portion 69.

Specifically, for example, the motion condition calculation section 63 recognizes a temporal change in the distance between the predetermined reference point and the main body as a single wave, and calculates the frequency, the amplitude, and the phase of the wave as the motion condition information Rm_j.

The estimation section 64 determines the identity of the operator, based on one of the temporal change and the spatial change in the touch extracted by the touch change extraction section 61. Subsequently, the touch condition calculation portion 62 provided in the estimation section 64 will be described.

The touch condition calculation portion 62 calculates the touch condition information Rs_i (i is a positive integer), which indicates the characteristic of the touch, based on one of the temporal change and the spatial change in the touch extracted by the touch change extraction section 61, and outputs the calculated touch condition information Rs_i to the operator estimation portion 69.

Specifically, for example, the touch condition calculation portion 62 recognizes the temporal change according to presence or absence of the touch as a single wave, and calculates the frequency, the amplitude, and the phase of the wave as one piece of touch condition information Rs_i. Likewise, the touch condition calculation portion 62 recognizes the spatial change according to the presence or absence of the touch as a single wave, and calculates the frequency, the amplitude, and the phase of the wave as one piece of touch condition information Rs_i.

Subsequently, the operator estimation portion 69 provided in the estimation section 64 will be described. The operator estimation portion 69 determines the identity of the operator, based on the touch condition information and the motion condition information. Specifically, for example, information o_(i, j) used to identify the operator is read from the storage unit 54. The information o_(i, j) used to identify the operator corresponds to combination between the touch condition information Rs_i, which is calculated by the touch condition calculation portion 62, and the motion condition information Rm_j which is calculated by the motion condition calculation section 63.

The operator estimation portion 69 outputs the read information o_(i, j) used to identify the operator to the output unit 53. Thereby, the output unit 53 displays, for example, the information o_(i, j) used to identify the operator on the display section DP.

Further, the control unit 60 uses the information o_(i, j) used to identify the operator, which is obtained by the operator estimation portion 69, in processing of authenticating the operator. For example, the control unit 60 may authenticate the operator when the information o_(i, j) used to identify the operator is the same as information of the registered person stored in the storage unit 54 in advance, and may release, for example, the IC card lock.

Thereby, the operator is able to reduce the time to input a password by pressing the touch panel TP provided in the electronic device. Further, whenever the operator is authenticated, it is possible to eliminate the inconvenience caused when the password is input by hand.

In addition, in the embodiment, the operator estimation portion 69 determines the identity of the operator based on the touch condition information and the motion condition information. However, the invention is not limited to this, and the operator estimation portion 69 may estimate the operator based on the calculated touch condition information.

Specifically, for example, in the storage unit 54, the touch condition information and the operator identification information, are stored in association with each other in advance, and thus the operator estimation portion 69 may estimate the operator by reading the operator identification information, which corresponds to the calculated touch condition information, from the storage unit 54.

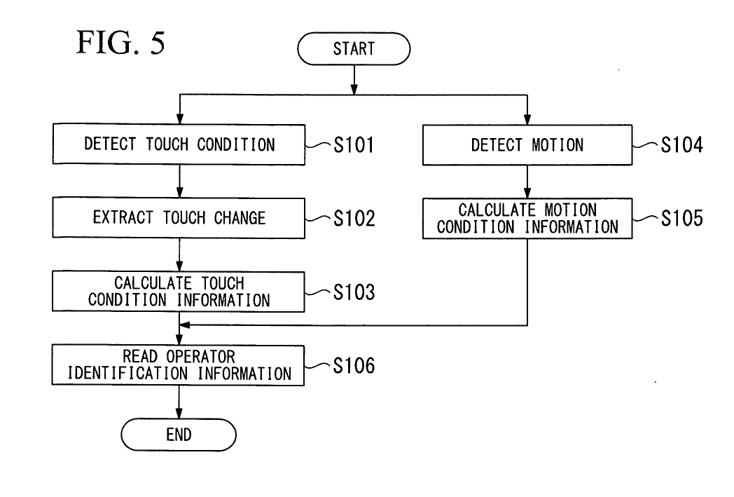

FIG. 5 is a flowchart showing a processing flow of the estimation of the operator in the first embodiment. First, the touch detection sections SD1 to SD4 detect the touch condition (step S101). Next, the touch change extraction section 61 extracts the touch change (step S102). Next, the touch condition calculation portion 62 calculates the touch condition information (step S103). Next, the motion detection section 52d detects the motion of the main body (step S104). Next, the motion condition calculation section 63 calculates the motion condition information (step S105). Next, the operator estimation portion 69 reads the information, which is used to identify the operator of the main body, from the storage unit 54 (step S106). The processing of the current flowchart hitherto described ends.

As described above, in the embodiment, the control unit 60 of the electronic device EQP reads the information, which is used to identify the operator of the main body, based on the touch condition information and the motion condition information. Thereby, it is possible to determine whether or not the information used to identify the operator of the main body is the same as the information which indicates the registered person stored in the storage unit 54 in advance. In addition, when the two information pieces are the same, the control unit 60 authenticates the operator.

Thereby, the operator is able to reduce the time to input a password by pressing the touch panel TP provided in the electronic device. Further, whenever the operator is authenticated, it is possible to eliminate the inconvenience caused when the password is input by hand.

### Second Embodiment

Subsequently, an electronic device EQP_b according to a second embodiment of the present invention will be described. Although a block configuration diagram thereof is omitted, in the configuration of the electronic device EQP_b according to the second embodiment, the storage unit 54 of the control device CONT of the electronic device EQP according to the first embodiment shown in FIG. 3 is changed to a storage unit 54b, and the control unit 60 is changed to a control unit 60b.

The storage unit 54b stores information pieces o_(l, l), . . . , and o_(m, n) (m and n are positive integers) which indicate operators, information pieces Rp_l, . . . , and Rp_m which indicate pressure conditions, and information pieces Rm_l, . . . , and Rm_n which indicate motion conditions, in association with each other. That is, in the storage unit 54b, the information o_(i, j), which indicates a single operator, is stored in association with each combination of the information Rs _i which indicates the pressure condition and the information Rm_j which indicates the motion condition (i and j are positive integers). Here, the information o_(i, j), which indicates a single operator, may be the same as information o_(i′, j′) which indicates another operator (i′ and j′ are positive integers).

The storage unit 54b stores information which indicates a registered person.

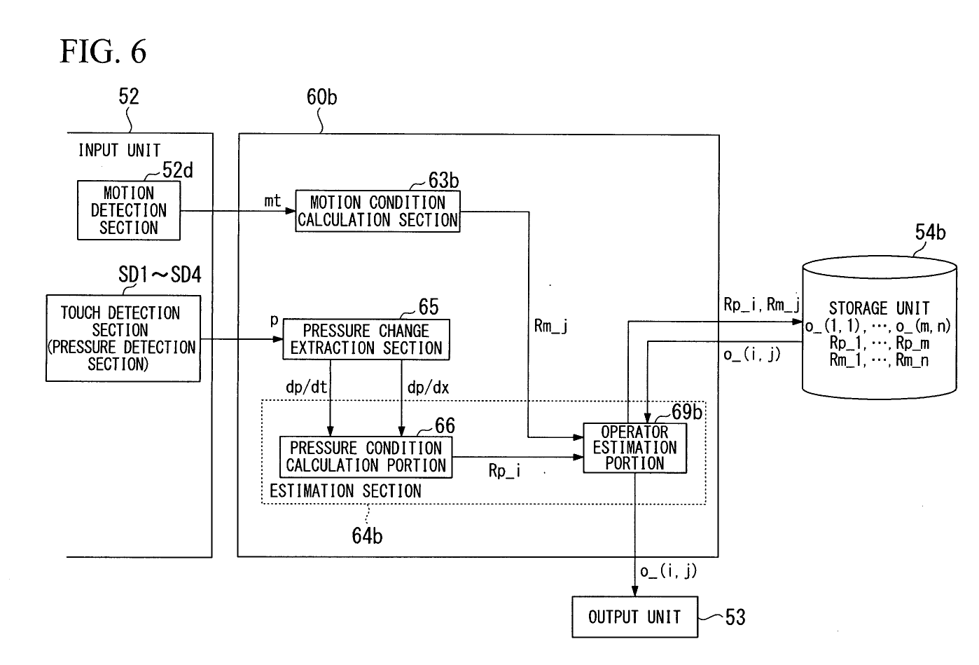

FIG. 6 is a block configuration diagram of the control unit 60b of the electronic device EQP_b according to the second embodiment. The control unit 60b includes a pressure change extraction section 65, a motion condition calculation section 63b, and an estimation section 64b. The estimation section 64b includes a pressure condition calculation portion 66, and an operator estimation portion 69b.

The pressure change extraction section 65 extracts one of the temporal change and the spatial change in the pressure detected by the touch detection sections SD1 to SD4, and outputs information dp/dt, which indicates the extracted temporal change in the pressure, and information dp/dx, which indicates the spatial change in the pressure, to the pressure condition calculation portion 66.

Specifically, for example, the pressure change extraction section 65 calculates the temporal change in the pressure at the positions of the touch detection sections SD1 to SD4, and outputs the information dp/dt, which indicates the temporal change in the pressure, to the pressure condition calculation portion 66.

Likewise, for example, in accordance with the pressure at each of the touch detection sections SD1 to SD4, the touch change extraction section 61 calculates the change in the length direction at each touch detection section, and outputs information, which indicates the change in the pressure in the length direction, as the information dp/dx, which indicates the spatial change in the pressure, to the pressure condition calculation portion 66.

The estimation section 64b determines the identity of the operator, based on one of the temporal change and the spatial change in the pressure extracted by the pressure change extraction section 65. Subsequently, the pressure condition calculation portion 66 provided in the estimation section 64b will be described. The pressure condition calculation portion 66 calculates the pressure condition information Rp_i (i is a positive integer), which indicates the characteristic of the pressure, based on one of the temporal change and the spatial change in the pressure extracted by the pressure change extraction section 65, and outputs the calculated pressure condition information Rp_i to the operator estimation portion 69b.

Specifically, for example, the pressure condition calculation portion 66 recognizes the temporal change in the pressure as a single wave, and calculates the frequency, the amplitude, and the phase of the wave as one piece of pressure condition information Rp_i. Likewise, the touch condition calculation portion 62 recognizes the spatial change in the pressure as a single wave, and calculates the frequency, the amplitude, and the phase of the wave as one piece of pressure condition information Rp_i.

In a similar manner to the motion condition calculation section 63, the motion condition calculation section 63b calculates the motion condition information Rm_j (j is a positive integer), which indicates the characteristic of the motion, based on the information mt which indicates the motion detected by the motion detection section 52d, and outputs the calculated motion condition information Rm_j to the operator estimation portion 69b.

Specifically, for example, the motion condition calculation section 63b recognizes a temporal change in the distance from the reference point of the main body as a single wave, and calculates the frequency, the amplitude, and the phase of the wave as the motion condition information Rm_j.

Subsequently, the operator estimation portion 69b provided in the estimation section 64b will be described. The operator estimation portion 69b estimates the operator of the main body, based on the pressure condition information, which is calculated by the pressure condition calculation portion 66, and the motion condition information which is calculated by the motion condition calculation section 63b.

Specifically, for example, the operator estimation portion 69b determines the identity of the operator of the main body by reading the information o_(i, j) used to identify the operator from the storage unit 54b. The information o_(i, j) used to identify the operator corresponds to combination between the pressure condition information Rp_i and the motion condition information Rm_j.

The operator estimation portion 69b outputs the read information o_(i, j) used to identify the operator to the output unit 53. Thereby, the output unit 53 displays, for example, the information o_(i, j) used to identify the operator on the display section DP.

Further, in a similar manner to the control unit 60, the control unit 60b uses the information o_(i, j) used to identify the operator, which is obtained by the operator estimation portion 69b, in processing of authenticating the operator. For example, the control unit 60b may authenticate the operator when the information o_(i, j) used to identify the operator is the same as information of the registered person which is stored in the storage unit 54b in advance.

Thereby, the operator is able to reduce the time to input a password by pressing the touch panel TP provided in the electronic device. Further, whenever the operator is authenticated, it is possible to eliminate the inconvenience caused when the password is input by hand.

In addition, in the embodiment, the operator estimation portion 69b determines the identity of the operator based on the pressure condition information and the motion condition information. However, the invention is not limited to this, and the operator estimation portion 69b may estimate the operator based on the calculated pressure condition information.

Specifically, for example, in the storage unit 54b, the pressure condition information and the operator identification information, are stored in association with each other in advance, and thus the operator estimation portion 69b may estimate the operator by reading the operator identification information, which corresponds to the calculated pressure condition information, from the storage unit 54b.

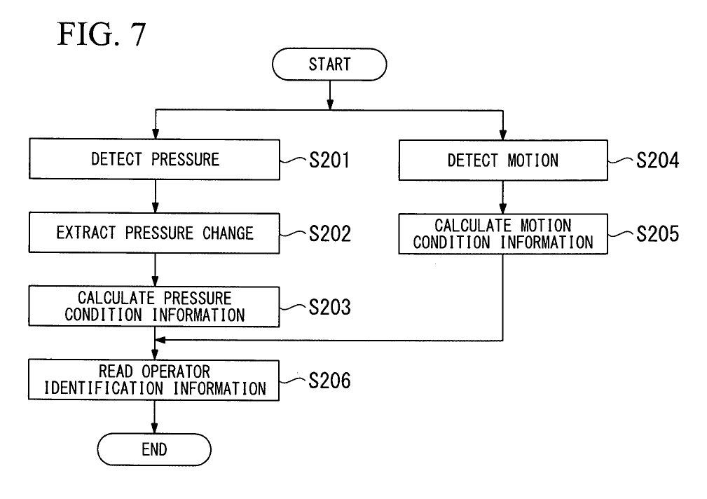

FIG. 7 is a flowchart showing a processing flow of the estimation of the operator in the second embodiment. First, the touch detection sections SD1 to SD4 detect the pressure which occurs when the operator touches the main body (step S201). Next, the pressure change extraction section 65 extracts one of the temporal change and the spatial change in the pressure (step S202). Next, the pressure condition calculation portion 66 calculates the pressure condition information (step S203). Next, the motion detection section 52d detects the motion of the main body (step S204). Next, the motion condition calculation section 63b calculates the motion condition information (step S205). Next, the operator estimation portion 69b reads the information, which is used to identify the operator of the main body, from the storage unit 54b (step S206). The processing of the current flowchart hitherto described ends.

As described above, in the embodiment, the control unit 60b of the electronic device EQP_b reads the information, which is used to identify the operator of the main body, based on the pressure condition information and the motion condition information. Thereby, it is possible to determine whether or not the information used to identify the operator of the main body is the same as the information indicating the registered person which is stored in the storage unit 54b in advance. In addition, when the two information pieces are the same, the control unit 60b authenticates the operator.

Thereby, the operator is able to reduce the time to input a password by pressing the touch panel TP provided in the electronic device. Further, whenever the operator is authenticated, it is possible to eliminate the inconvenience caused when the password is input by hand.

### Third Embodiment

Subsequently, an electronic device EQP_c according to a third embodiment of the present invention will be described. Although a block configuration diagram thereof is omitted, in the configuration of the electronic device EQP_c according to the third embodiment, the storage unit 54 of the control device CONT of the electronic device EQP according to the first embodiment shown in FIG. 3 is changed to a storage unit 54c, and the control unit 60 is changed to a control unit 60c.

The storage unit 54c stores information pieces o_(l, l), . . . , and o_(m, n) (m and n are positive integers) which indicate operators, information pieces Hs_l, . . . , and Hs_m which indicate touch habits, and information pieces Hm_l, . . . , and Hm_n which indicate motion habits, in association with each other. That is, in the storage unit 54c, the information o_(i, j), which indicates a single operator, is stored in association with each combination of the information Hs_i which indicates the touch habit and the information Hm_j which indicates the motion habit (i and j are positive integers). Here, the information o_(i, j), which indicates a single operator, may be the same as information o_(i′, j′) which indicates another operator (i′ and j′ are positive integers).

The storage unit 54c stores information which indicates a registered person.

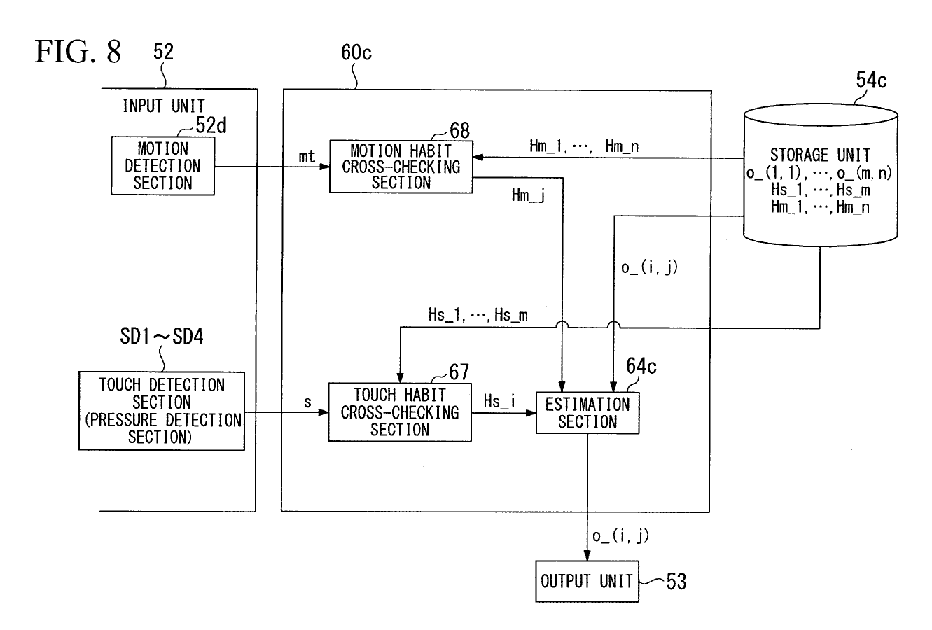

FIG. 8 is a block configuration diagram of the control unit 60c of the electronic device EQP_c according to the third embodiment. The control unit 60c includes a touch habit cross-checking section 67, a motion habit cross-checking section 68, and an estimation section 64c.

The touch habit cross-checking section 67 reads touch habit information, from the storage unit 54c, cross-checks the read touch habit information, with the detected touch condition, and outputs the touch habit information extracted by the cross-checking, to the estimation section 64c.

The motion habit cross-checking section 68 reads information, which indicates the motion habit, from the storage unit 54c, cross-checks the detected motion with the read information which indicates the motion habit, and outputs the information, which indicates the motion habit extracted by the cross-checking, to the estimation section 64c.

The estimation section 64c determines the identity of the operator by reading the operator identification information, from the storage unit 54c. The operator identification information, is associated with the touch habit information cross-checked by the touch habit cross-checking section 67, and the information which indicates the motion habit cross-checked by the motion habit cross-checking section 68.

In addition, in the storage unit 54c, the operator identification information, and the touch habit information regarding touch habits of the operator as performed on the main body, may be stored in association with each other. In this case, the estimation section 64c may estimate the operator by reading the operator identification information, which is associated with the information indicating the touch habit cross-checked by the touch habit cross-checking section 67, from the storage unit 54c.

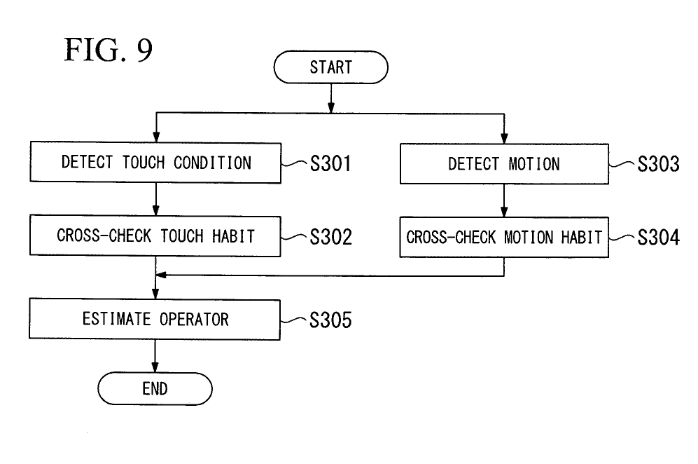

FIG. 9 is a flowchart showing a processing flow of the estimation of the operator in the third embodiment. First, the touch detection sections SD1 to SD4 detect the condition of the touch which is performed when the operator touches the main body (step S301). Next, the touch habit cross-checking section 67 cross-checks the touch habit (step S302). Next, the motion detection section 52d detects the motion of the main body (step S303). Next, the motion habit cross-checking section 68 cross-checks the motion habit (step S304). Next, the estimation section 64c reads the information, which is used to identify the operator of the main body, corresponding to the touch habit information, and the information, which indicates the motion habit, from the storage unit 54c (step S306). The processing of the current flowchart hitherto described ends.

As described above, in the embodiment, the control unit 60c of the electronic device EQP_c reads the information, which is used to identify the operator of the main body, based on the touch habit information, and the information which indicates the motion habit. Thereby, it is possible to determine whether or not the information used to identify the operator of the main body is the same as the information indicating the registered person which is stored in the storage unit 54c in advance. In addition, when the two information pieces are the same, the control unit 60c authenticates the operator.

Thereby, the operator is able to reduce the time to input a password by pressing the touch panel TP provided in the electronic device. Further, whenever the operator is authenticated, it is possible to eliminate the inconvenience caused when the password is input by hand.

### Fourth Embodiment

Subsequently, an electronic device EQP_d according to a fourth embodiment of the present invention will be described. Although a block configuration diagram thereof is omitted, in the configuration of the electronic device EQP_d according to the fourth embodiment, the storage unit 54 of the control device CONT of the electronic device EQP according to the first embodiment shown in FIG. 3 is changed to a storage unit 54d, and the control unit 60 is changed to a control unit 60d.

In the storage unit 54d, the information o_(i, j), which indicates a single operator, is stored in association with each combination of information s_i, which indicates the touch condition, and information mt_j which indicates the motion (i and j are positive integers). The information s_i is one of the information pieces s_l, . . . , and s_m (m is a positive integer) which indicate the touch conditions. The information mt_j is one of the information pieces mt_l, . . . , and mt_n (n is a positive integer) which indicate the motions. Here, the information o_(i, j), which indicates a single operator, may be the same as information o_(i′, j′) which indicates another operator (i′ and j′ are positive integers).

The storage unit 54d stores information which indicates a registered person.

Likewise, in the storage unit 54d, the information o′_(i, k), which indicates a single operator, is stored in association with each combination of information s_i, which indicates the touch condition, and motion condition information Rm_k (i and k are positive integers). The information s_i is one of the information pieces s_1, . . . , and s_m (m is a positive integer) which indicate the touch conditions. The motion condition information Rm_k is one of the motion condition information pieces Rm_1, . . . , and s_l (l is a positive integer). Here, the information o′(i, k), which indicates a single operator, may be the same as information o′_(i′, k′) which indicates another operator (i′ and k′ are positive integers).

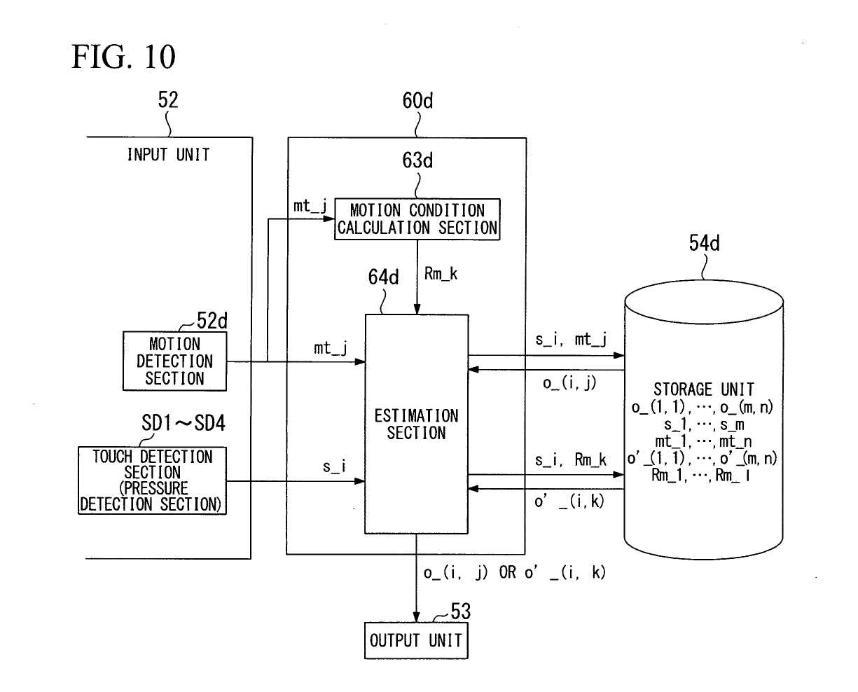

FIG. 10 is a block configuration diagram of the control unit 60d of the electronic device EQP_d according to the fourth embodiment. The control unit 60d includes a motion condition calculation section 63d and an estimation section 64d.

In a similar manner to the motion condition calculation section 63, the motion condition calculation section 63d calculates the motion condition information Rm_k (k is a positive integer), which indicates the characteristic of the motion, based on the information mt_j which indicates the motion detected by the motion detection section 52d, and outputs the calculated motion condition information Rm_k to the estimation section 64d.

Specifically, for example, the motion condition calculation section 63d recognizes a temporal change in the distance from the reference point of the main body as a single wave, and calculates the frequency, the amplitude, and the phase of the wave as the motion condition information Rm_k.

The estimation section 64d estimates the operator based on the touch condition, which is detected by the touch detection sections SD1 to SD4, and the motion which is detected by the motion detection section 52d.

Specifically, for example, the estimation section 64d determines the identity of the operator by reading the information o_(i, j), which is used to identify the operator, from the storage unit 54d. The information o_(i, j) corresponds to combination of the information s_i, which indicates the touch condition detected by the touch detection sections SD1 to SD4, and the information mt_j which indicates the motion detected by the motion detection section 52d.

When being unable to estimate the operator through the processing, the estimation section 64d estimates the operator, based on the touch condition, which is detected by the touch detection sections SD1 to SD4, and the motion condition information which is detected by the motion condition calculation section 63d.

Specifically, for example, the estimation section 64d determines the identity of the operator by reading the information o′_(i, k), which is used to identify the operator, from the storage unit 54d. The information o′_(i, k) corresponds to combination of the information s_i, which indicates the touch condition detected by the touch detection sections SD1 to SD4, and the motion condition information Rm_k which is detected by the motion condition calculation section 63d.

The estimation section 64d outputs the read information o_(i, j) or o′_(i, k), which is used to identify the operator, to the output unit 53. Thereby, the output unit 53 displays, for example, information o_(i, j) or o′_(i, k), which is used to identify the operator, on the display section DP. Further, the control unit 60d uses the information o_(i, j) or o′_(i, k) used to identify the operator, which is obtained by the estimation section 64d, in the processing of authenticating the operator.

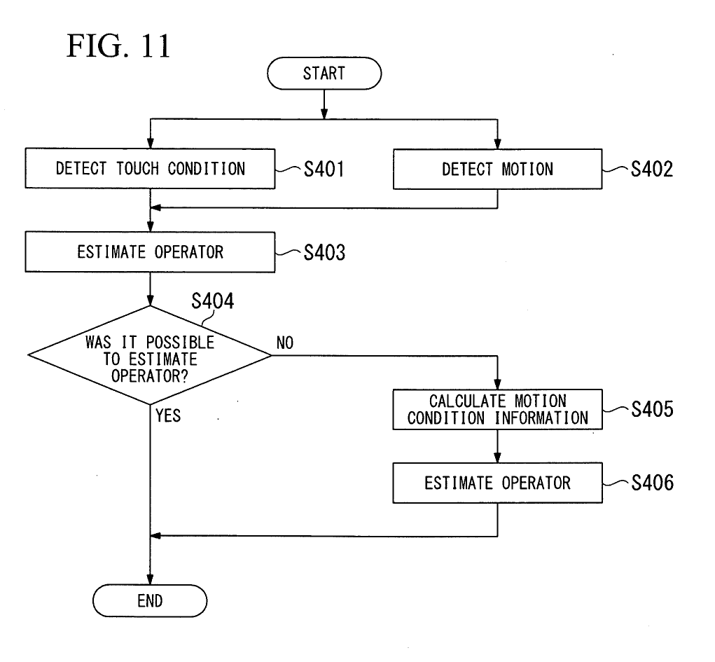

FIG. 11 is a flowchart showing a processing flow of the estimation of the operator in the fourth embodiment. First, the touch detection sections SD1 to SD4 detect the touch condition (step S401). Next, the motion detection section 52d detects the motion of the main body (step S402). Next, the estimation section 64d determines the identity of the operator based on the touch condition and the motion (step S403).

Next, the estimation section 64d determines whether or not it was possible to estimate the operator (step S404). If the estimation section 64d was able to estimate the operator (step S404 YES), the control unit 60d ends the processing.

In contrast, if the estimation section 64d was unable to estimate the operator (step S404 NO), the motion condition calculation section 63d calculates the motion condition information (step S405). Next, the estimation section 64d determines the identity of the operator based on the touch condition and the motion condition information (step S406). The processing of the current flowchart hitherto described ends.

As described above, the control unit 60d of the electronic device EQP_d in the embodiment reads the information, which is used to identify the operator of the main body, based on the touch condition and the motion. Further, the control unit 60d reads the information, which is used to identify the operator of the main body, based on the touch condition and the motion condition. Thereby, the control unit 60d is able to determine whether or not the information, which is used to identify the operator of the main body, is the same as the information which indicates the registered person stored in the storage unit 54d in advance. In addition, when the two information pieces are the same, the control unit 60d authenticates the operator.

Thereby, the operator is able to reduce the time to input a password by pressing the touch panel TP provided in the electronic device. Further, whenever the operator is authenticated, it is possible to eliminate the inconvenience caused when the password is input by hand.

In the embodiment, the estimation section 64d first determines the identity of the operator based on the touch condition and the motion, and the estimation section 64d then determines the identity of the operator based on the touch condition and the motion condition when being unable to estimate the operator. However, the invention is not limited to this. The estimation section 64d may first estimate the operator based on the touch condition and the motion condition. Further, the estimation section 64d may first estimate the operator based on the touch condition and the motion condition, and may estimate the operator based on the touch condition and the motion when being unable to estimate the operator.

In addition, the control unit (60, 60b, 60c, or 60d) may estimate the operator of the main body in a case of a special hand grip method which is not a normal hand grip method.

Specifically, for example, in the storage unit, information, which indicates the touch distribution in the case of the special hand grip method which is not the normal hand grip method, is stored, in advance, in association with the operator identification information. In this case, the control unit (60, 60b, 60c, or 60d) cross-checks the touch distribution, which is stored in the storage unit in the case of the special hand grip method, with the touch distribution which is detected by the touch detection sections SD1 to SD4. When determining that the touch distributions are the same through the cross-checking, the control unit (60, 60b, 60c, or 60d) determines the identity of the operator of the main body by reading the operator identification information from the storage unit. The operator identification information corresponds to the touch distribution in the case of the special hand grip method.

Further, the control unit (60, 60b, 60c, or 60d) may estimate the operator of the main body when the operator grips the main body in accordance with the order of the hand grip method stored in the storage unit in advance.

Specifically, for example, in the storage unit, the information, which indicates the touch distribution corresponding to the hand grip method, is stored in advance, and thus the operator identification information is stored in association with each combination of the sorting orders of the information pieces which indicate the touch distributions corresponding to the hand grip methods.

In this case, the control unit (60, 60b, 60c, or 60d) cross-checks the touch distribution, which corresponds to the hand grip method stored in the storage unit, with the touch distribution, which is detected by the touch detection sections SD1 to SD4, in the sorting order of the information pieces which indicate the touch distributions corresponding to the hand grip methods. When determining that the main body is gripped in the order of the hand grip method through the cross-checking, the control unit (60, 60b, 60c, or 60d) determines the identity of the operator of the main body by reading the operator identification information from the storage unit. The operator identification information corresponds to the sorting order of the information pieces which indicate the touch distributions corresponding to the hand grip methods.

Further, when the operator identification information is stored in the storage unit in advance in association with the habit of the motion of the main body, the habit of the motion of the main body stored in the storage unit in advance may be the same as that of the motion detected by the motion detection section. In this case, the control unit (60, 60b, 60c, or 60d) may estimate the operator of the main body by reading the operator identification information from the storage unit. The operator identification information corresponds to the habit of the motion of the main body.

Furthermore, the control unit (60, 60b, 60c, or 60d) may estimate characteristics of the hand of the operator from the touch distribution which is detected by the touch detection sections SD1 to SD4, and may estimate the operator, based on the characteristics of the hand (for example, the size of the palm and a state where fingers are open).

In addition, programs for executing respective processes of the electronic devices EQP, EQP_b, EQP_c, and EQP_d of the embodiments are recorded in a computer readable recording medium. The programs recorded in the recording medium are read and executed by a computer system, whereby the above-mentioned various processes relating to the electronic device EQP may be performed.

In each embodiment, when the information used to identify the operator of the main body is the same as the information which indicates the registered person stored in the storage unit in advance, approval of the operator is performed. However, when the information used to identify the operator of the main body is similar to the information which indicates the registered person stored in the storage unit in advance, the approval of the operator may be performed.

The determination as to whether or not the information pieces are similar is made based on, for example, whether or not the information, which is used to identify the operator of the main body, is the same as information within a predetermined range similar to the information which indicates the registered person stored in the storage unit in advance. In this case, the information used to identify the operator of the main body, on which the approval of the operator is completed, is updated and recorded as the information which indicates the registered person stored in the storage unit in advance. In such a manner, it is possible to cope with a case where the habit of the operator changes with time.

It should be noted that the “computer system” described herein may include OS and hardware such as peripheral devices. Further, when using a WWW system, it is assumed that the “computer system” also includes an environment (or a display environment) for providing a homepage. Furthermore, the “computer readable recording medium” is defined to include storage devices such as a flexible disk and a magneto optical disc, a ROM, a writable nonvolatile memory such as a flash memory, a portable medium such as a CD-ROM, and a hard disk built into the computer system.

Moreover, the “computer readable recording medium” is also defined to include a medium which holds a program for a certain period of time like a volatile memory (for example, dynamic random access memory (DRAM)) inside the computer system functioning as a server or a client in a case where the program is transmitted through a network such as the Internet or a communication line such as a telephone line. Further, the program may be transmitted from the computer system, in which the program is stored in the storage device or the like, to another computer system via a transmission medium or a transmitted wave in a transmission medium. Here, the “transmission medium”, which transmits the program, is defined as a medium which has a function of transmitting information like the network (communication network) such as the Internet or a communication line (communication link) such as a telephone line. Further, the program may be to implement some of the above-mentioned functions. Furthermore, the program may be a program which implements the above-mentioned functions through combination of programs recorded in the computer system in advance, that is, may be a so-called differential file (differential program).

The embodiments of the invention have been hitherto described with reference to the drawings. However, the detailed configuration is not limited to the embodiments, and the invention includes a design and the like without departing from the technical scope of the invention.

1. An electronic device comprising:
a touch detection section that is disposed on a side surface of a casing of a main body so as to detect a touch condition when an operator touches the main body;
a touch change extraction section that extracts one of a temporal change and a spatial change in the touch based on the detected touch condition; and
an estimation section that determines the identity of the operator based on the one of the extracted temporal change and spatial change in the touch.

2. The electronic device according to claim 1, wherein the estimation section includes a touch condition calculation portion that calculates touch condition information indicating characteristics of the touch based on the one of the extracted temporal change and spatial change in the touch, and an operator estimation portion that determines the identity of the operator based on the calculated touch condition information.

3. The electronic device according to claim 2, further comprising:
a motion detection section that detects a motion of the casing of the main body when the operator moves the main body; and
a motion condition calculation section that calculates motion condition information indicating characteristics of the motion based on the detected motion,
wherein the operator estimation portion determines the identity of the operator based on the touch condition information and the motion condition information.

4. An electronic device comprising:
a pressure detection section that is disposed on a side surface of a casing of a main body so as to detect pressure when an operator touches the main body;
a pressure change extraction section that extracts one of a temporal change and a spatial change in the pressure which is detected by the pressure detection section; and
an estimation section that determines the identity of the operator based on the one of the extracted temporal change and spatial change in the pressure.

5. The electronic device according to claim 4, wherein the estimation section includes a pressure condition calculation portion that calculates pressure condition information indicating characteristics of the pressure based on the one of the extracted temporal change and spatial change in the pressure, and an operator estimation portion that determines the identity of the operator based on the calculated pressure condition information.

6. The electronic device according to claim 5, further comprising:
a motion detection section that detects a motion of the casing of the main body when the operator moves the main body; and
a motion condition calculation section that calculates motion condition information indicating characteristics of the motion based on the detected motion,
wherein the operator estimation portion determines the identity of the operator based on the pressure condition information and the motion condition information.

7. An electronic device comprising:
a touch detection section that is disposed on a side surface of a casing of a main body so as to detect a touch condition when an operator touches the main body;
a storage unit that stores operator identification information, and touch habit information regarding touch habits of the operator as performed on the main body, in association with each other;
a touch habit cross-checking section that reads the touch habit information from the storage unit and cross-checks the read touch habit information with the detected touch condition; and
an estimation section that determines the identity of the operator by reading, from the storage unit, the operator identification information associated with the touch habit information cross-checked by the touch habit cross-checking section.

8. An electronic device comprising:
a touch detection section that is disposed on a side surface of a casing of a main body so as to detect a touch condition when an operator touches the main body;
a motion detection section that detects a motion of the casing of the main body when the operator moves the main body;
a storage unit that stores operator identification information, touch habit information regarding touch habits of the operator as performed on the main body, and motion habit information as a habit of motion performed on the main body by the operator, in association with each other;
a touch habit cross-checking section that reads the touch habit information from the storage unit and cross-checks the read touch habit information with the detected touch condition; and
a motion habit cross-checking section that reads the information, which indicates the motion habit, from the storage unit and cross-checks the read information, which indicates the motion habit, with the detected motion; and
an estimation section that determines the identity of the operator by reading, from the storage unit, the operator identification information associated with the touch habit information cross-checked by the touch habit cross-checking section, and the information which indicates the motion habit cross-checked by the motion habit cross-checking section.

9. An electronic device comprising:
a touch detection section that is disposed on a side surface of a casing of a main body so as to detect a touch condition when an operator touches the main body;
a motion detection section that detects a motion of the casing of the main body; and
an estimation section that determines the identity of the operator based on the detected touch condition and the detected motion.

10. The electronic device according to claim 9, further comprising:
a motion condition calculation section that calculates motion condition information indicating characteristics of the motion based on the detected motion,
wherein the estimation section determines the identity of the operator based on the detected touch condition and the calculated motion condition information.

11. The electronic device according to claim 1, wherein the touch detection section can be divided into an arbitrary number of points equal to or greater than one point.

12. The electronic device according to claim 4, wherein the pressure detection section can be divided into an arbitrary number of points equal to or greater than one point.

13. An operator estimation method that is executed by an electronic device having a touch detection section which is disposed on a side surface of a casing of a main body so as to detect a touch condition when an operator touches the main body, the method comprising:
a touch change extraction step of extracting one of a temporal change and a spatial change in the touch when the operator touches the main body; and
an estimation step of determining the identity of the operator based on the one of the extracted temporal change and spatial change in the touch.

14. A program for causing a computer of an electronic device having a touch detection section, which is disposed on a side surface of a casing of a main body so as to detect a touch condition when an operator touches the main body, to execute:
a touch change extraction step of extracting one of a temporal change and a spatial change in the touch when the operator touches the main body; and
an estimation step of determining the identity of the operator based on the one of the extracted temporal change and spatial change in the touch.
